(19) United States
(12) Patent Application Publication
(10) Pub. No.: US 2025/0153647 A1
(43) Pub. Date: May 15, 2025

(54) LOAD FLOOR FOR A VEHICLE WITH A STOWING SEAT

(71) Applicant: Atieva, Inc., Newark, CA (US)

(72) Inventors: Alejandro Pinto, Dublin, CA (US); Amol Y. Sandbhor, Union City, CA (US); Cristian Alvaro Araneda Urrutia, Cupertino, CA (US); Zeb Michael Coughenour, Redwood City, CA (US); Jiacheng He, Newark, CA (US); Lukas BONGHOON Chung, San Dimas, CA (US); Jacek Helmt Tomiczek, Mazancowice (PL)

(21) Appl. No.: 18/510,169

(22) Filed: Nov. 15, 2023

(51) Int. Cl. B60R 5/04; B62D 25/08

(52) U.S. Cl. CPC B60R 5/044; B62D 25/087

(57) ABSTRACT

A load floor to cover a sub-trunk compartment in a vehicle can include: first, second and third boards, wherein the first board and the second board are hinged to each other, and wherein the second and third boards are hinged to each other; and a torsion spring providing a bias for the first board to assume a nonzero angle relative to the second board; and either a magnet or a metal plate included in the first board. The load floor can include a retainer mechanism at a side wall of the trunk space.

### TECHNICAL FIELD

This document relates to a load floor for a vehicle with a stowing seat.

### BACKGROUND

Vehicle seats can be designed for the dual purposes of providing a seat for an occupant and for being folded to facilitate use of a load floor for luggage or other vehicle cargo. Previous approaches in load floor design have reflected the specifics of the seats and trunk space of their respective vehicles.

### SUMMARY

In a first aspect, a load floor to cover a sub-trunk compartment in a vehicle comprises: first, second and third boards, wherein the first board and the second board are hinged to each other, and wherein the second and third boards are hinged to each other; a torsion spring providing a bias for the first board to assume a nonzero angle relative to the second board; and either a magnet or a metal plate included in the first board, the magnet or the metal plate configured for attraction to another of the magnet or the metal plate to overcome the bias and cause the first board to assume an angle of about zero degrees relative to the second board.

Implementations can include any or all of the following features. The first board is a front board, the second board is a middle board, and the third board is a rear board. The load floor is configured to be supported by flanges positioned adjacent the sub-trunk compartment, and wherein each of the first, second and third boards includes a respective supporting surface. In a first use position of the load floor the flanges abut the supporting surfaces of each of the first, second and third boards. In a second use position of the load floor the flanges abut the supporting surfaces of each of the second and third boards and the flanges do not abut the supporting surface of the first board. In a third use position of the load floor the flanges abut the supporting surface of the second board and the flanges do not abut the supporting surfaces of each of the first and third boards, wherein the first and third boards are in rotated positions and the second board is in a flat position. The magnet or the metal plate is configured so that attraction between i) the magnet or the metal plate and ii) another of the magnet or the metal plate positioned at the flanges causes the flanges to abut also the supporting surface of the first board. The first board and the second board are hinged to each other by a living hinge. The second and third boards are hinged to each other by a living hinge. The load floor further comprises a handle. The handle is positioned at the third board, and wherein the third board is positioned at a rear of the load floor. The nonzero angle is substantially 90 degrees. The first board comprises i) a left first board that is hinged to the second board, and ii) a right first board that is hinged to the second board.

In a second aspect, a load floor to cover a sub-trunk compartment in a vehicle comprises: a rear board, a middle board, and a front board, wherein the load floor is configured to be supported by flanges positioned adjacent the sub-trunk compartment, wherein each of the rear, middle and front boards includes a respective supporting surface, wherein in a first use position the flanges abut the supporting surfaces of each of the rear, middle and front boards, and wherein in a second use position the flanges abut the supporting surfaces of each of the rear and middle boards and the flanges do not abut the supporting surface of the front board; a first hinge that hinges the rear board and the middle board to each other, the first hinge mounted to a distal edge of the rear board and to a proximate edge of the middle board; a second hinge that hinges the middle board and the front board to each other, the second hinge mounted to a distal edge of the middle board and to a proximate edge of the front board; and a torsion spring that biases the front board toward a nonzero angle relative to the middle board, the torsion spring mounted to the distal edge of the middle board and to the proximate edge of the front board; wherein the front board includes either a magnet or a metal plate adjacent the supporting surface of the front board, wherein the magnet or the metal plate is configured so that attraction between i) the magnet or the metal plate and ii) another of the magnet or the metal plate causes the flanges to abut also the supporting surface of the front board.

Implementations can include any or all of the following features. The first hinge is a living hinge. The first second is a living hinge. The nonzero angle is substantially 90 degrees. In a third use position the flanges abut the supporting surface of the middle board and the flanges do not abut the supporting surfaces of each of the front and rear boards, wherein the front and rear boards are in rotated positions and the second board is in a flat position.

In a third aspect, a vehicle comprises: a vehicle body having a passenger compartment and a trunk space, wherein a sub-trunk compartment is formed in the trunk space; at least one seat that is configured to transition between a deployed position and a stowed position, wherein in the deployed position the seat is positioned in front of the sub-trunk compartment and is available for sitting by an occupant in the passenger compartment, and wherein in the stowed position the seat is stowed inside the sub-trunk compartment; and a load floor to cover the sub-trunk compartment when the seat is in the deployed position and in the stowed position, the load floor comprising: first, second and third boards, wherein the first board and the second board are hinged to each other, wherein the second and third boards are hinged to each other, and wherein the load floor provides a bias for the first board to assume a nonzero angle relative to the second board; and either a magnet or a metal plate included in the first board to overcome the bias and cause the first board to assume a zero angle relative to the second board.

Implementations can include any or all of the following features. The first board is a front board, the second board is a middle board, and the third board is a rear board. The load floor is configured to be supported by flanges positioned adjacent the sub-trunk compartment, and wherein each of the first, second and third boards includes a respective supporting surface. In a first use position of the load floor the flanges abut the supporting surfaces of each of the first, second and third boards. In a second use position of the load floor the flanges abut the supporting surfaces of each of the second and third boards and the flanges do not abut the supporting surface of the first board. The magnet or the metal plate is configured so that attraction between i) the magnet or the metal plate and ii) another of the magnet or the metal plate positioned at the flanges causes the flanges to abut also the supporting surface of the first board. The first board and the second board are hinged to each other by a living hinge. The second and third boards are hinged to each other by a living hinge. The vehicle further comprises a handle. The handle is positioned at the third hinge, and wherein the third board is positioned at a rear of the load floor. The nonzero angle is substantially 90 degrees. The load floor is configured for the third board to be rotated, relative to the second board, into an open position that allows access to the sub-trunk compartment. The vehicle further comprises a retainer mechanism mounted to a side wall of the trunk space, the retainer mechanism having at least a first position where the third board can be rotated past the retainer mechanism, and a second position where the third board cannot be rotated past the retainer mechanism. The first board comprises i) a left first board that is hinged to the second board, and ii) a right first board that is hinged to the second board.

In a fourth aspect, a vehicle comprises: a vehicle body having a passenger compartment and a trunk space, wherein a sub-trunk compartment is formed in the trunk space; at least one seat that is configured to transition between a deployed position and a stowed position, wherein in the deployed position the seat is positioned in front of the sub-trunk compartment and is available for sitting by an occupant in the passenger compartment, and wherein in the stowed position the seat is stowed inside the sub-trunk compartment; a load floor to cover the sub-trunk compartment when the seat is in the deployed position and in the stowed position, the load floor comprising first, second and third boards, wherein the first board and the second board are hinged to each other, and wherein the second and third boards are hinged to each other; and a first retainer mechanism at a side wall of the trunk space, the first retainer mechanism comprising a wedge-shaped member that is biased into an extended position.

Implementations can include any or all of the following features. The wedge-shaped member defines a base contour and a pointed end. The first retainer mechanism further comprises an axle extending through the pointed end in a substantially vertical direction, and wherein the wedge-shaped member is configured to rotate in a substantially horizontal direction about the axle. The load floor further comprises a torsion spring providing a bias for the first board to assume a nonzero angle relative to the second board. The nonzero angle is substantially 90 degrees. The load floor further comprises either a magnet or a metal plate included in the first board, the magnet or the metal plate configured for attraction to another of the magnet or the metal plate to overcome the bias and cause the first board to assume an angle of about zero degrees relative to the second board. The vehicle further comprises flanges positioned adjacent the sub-trunk compartment, wherein the load floor is configured to be supported by the flanges, and wherein each of the first, second and third boards includes a respective supporting surface. In a first use position of the load floor the flanges abut the supporting surfaces of each of the first, second and third boards. In a second use position of the load floor the flanges abut the supporting surfaces of each of the second and third boards and the flanges do not abut the supporting surface of the first board. In a third use position of the load floor the flanges abut the supporting surface of the second board and the flanges do not abut the supporting surfaces of each of the first and third boards, wherein the first and third boards are in rotated positions and the second board is in a flat position. The load floor further comprises either a magnet or a metal plate included in the first board, wherein the magnet or the metal plate is configured so that attraction between i) the magnet or the metal plate and ii) another of the magnet or the metal plate positioned at the flanges causes the flanges to abut also the supporting surface of the first board. The first board and the second board are hinged to each other by a living hinge. The second and third boards are hinged to each other by a living hinge. The load floor further comprises a handle. The handle is positioned at the third board, and wherein the third board is positioned at a rear of the load floor. The first board comprises i) a left first board that is hinged to the second board, and ii) a right first board that is hinged to the second board. The first board is a front board, the second board is a middle board, and the third board is a rear board. When the wedge-shaped member is in the extended position, a portion of the base contour is positioned in a path for the third board to reach a rotated position relative to the second board. The vehicle further comprises interior trim in the trunk space, the interior trim forming a shape, and wherein in a rotated position of the third board, the third board is confined between the shape and the wedge-shaped member. The first retainer mechanism is configured so that as the third board is rotated toward the rotated position the wedge-shaped member is temporarily moved by the third board, against a bias of the first retainer mechanism, toward a retracted position. The first retainer mechanism is configured so that as the third board assumes the rotated position, the wedge-shaped member returns to the extended position, thereby confining the third board between the shape and the wedge-shaped member. The first retainer mechanism and the load floor are configured for actuation of the wedge-shaped member away from the extended position to release the third board. Upon actuation of the wedge-shaped member the third board is rotated out of confinement by gravity. The third board is rotated out of the confinement by gravity to a first position where the third board abuts the wedge-shaped member and temporarily prevents the wedge-shaped member from returning to the extended position, or to a second position past the wedge-shaped member. The vehicle further comprises a second retainer mechanism at an opposite side wall from the first retainer mechanism. The second retainer mechanism includes structure substantially corresponding to the first retainer mechanism.

### BRIEF DESCRIPTION OF DRAWINGS

FIG. 1 shows an example of a vehicle with a load floor.

FIG. 2 shows an example of the seat of the vehicle of FIG. 1 in a folded position.

FIG. 3 shows an example of the seat of the vehicle of FIG. 1 in a stowed position.

FIG. 4 shows an example of the vehicle of FIG. 1 with both of the seats in the deployed position.

FIG. 5A shows an example of the vehicle of FIG. 1 with the load floor in a flat position.

FIG. 5B shows an example of the vehicle of FIG. 1 with the rear board of the load floor in a rotated position.

FIG. 6 shows an example of the load floor of FIG. 1.

FIG. 7 shows an example cross section of the load floor of FIG. 6.

FIG. 8 shows an example of the load floor of FIG. 1 in a position where the front board is in a rotated position.

FIG. 9 shows an example of the load floor of FIG. 1 in a position where the front and rear boards are in rotated positions.

FIG. 10 shows an example of the load floor of FIG. 1 in a position where all of the boards are in flat positions.

FIG. 11 shows an example of a hinge between the front and middle boards of the load floor of FIG. 1.

FIG. 12 shows another example of the front and middle boards of the load floor of FIG. 1.

FIG. 13 shows a diagram with an example of bias on a board of a load floor.

FIG. 14 shows an example of a magnet and a metal plate that can be used with a board of a load floor.

FIG. 15 shows an example of the retainer mechanism of the vehicle of FIG. 1 at a side wall of the trunk space.

FIG. 16 shows an example of the retainer mechanism of FIG. 15.

FIG. 17 shows an exploded view of the retainer mechanism of FIG. 16.

FIG. 18 shows an example of the rear board of the load floor of FIG. 1 being confined between the wedge-shaped member and the interior trim.

FIG. 19 shows an example where the rear board of the load floor of FIG. 1 abuts the wedge-shaped member of the retainer mechanism.

FIG. 20 shows an example of the rear board of the load floor of FIG. 1 in a position past the wedge-shaped member of the retainer mechanism.

Like reference symbols in the various drawings indicate like elements.

### DETAILED DESCRIPTION

This document describes examples of systems and techniques relating to a load floor for a vehicle with a stowing seat. In some implementations, the seat is configured for being folded and stowed in a rearward direction, so that the stowed seat is accommodated in a sub-trunk compartment at a bottom of the trunk space. A load floor according to the present subject matter can provide one or more advantages in such and/or other implementations. For example, the load floor can provide a flexible solution for ensuring that seat mechanics are covered (e.g., not immediately visible or readily touchable) in various configuration of the foldable seat. As another example, the load floor can provide reliable cargo support solutions in various configuration of the foldable seat. As another example, the load floor can be easily removable for seat transition operations. As another example, the load floor can be designed to facilitate proper installation. As another example, the load floor can be designed to provide convenient and flexible opening and closing functionality for accessing the underlying sub-trunk compartment.

Examples herein refer to a vehicle. As used herein, a vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle, or the vehicle can be unpowered (e.g., when a trailer is attached to another vehicle). The vehicle can include a passenger compartment accommodating one or more persons.

Examples described herein refer to a sub-trunk compartment in the body of a vehicle. As used herein, a sub-trunk compartment is a hollow space formed in a trunk space of a vehicle in which at least one vehicle seat can be accommodated. The sub-trunk compartment may have any shape and sufficient volume that the vehicle seat (e.g., in a folded state) can entirely fit within the hollow space. For example, the sub-trunk compartment may be configured to be closed off by a lid both with and without the vehicle seat being stowed inside the tub compartment.

Examples described herein refer to a living hinge. As used herein, a living hinge is a substrate connecting items to each other, the substrate being sufficiently thin that it facilitates at least a specified amount of rotation (hinging) between the items depending on the design. The substrate can be made of a material that is common to the items.

Examples described herein refer to a retainer mechanism for a board of a load floor. As used herein, a retainer mechanism is a hardware component designed to retain the board in one or more positions or to otherwise restrict rotation or movement of the board.

Examples described herein refer to a use position of a load floor having multiple boards. As used herein, a use position is any of multiple positions or configurations into which the load floor can be placed. For example, one or more of the boards can be in a rotated position in a use position. As another example, one or more of the boards can be in a flat position in a use position.

Examples described herein refer to a top, bottom, front, side, or rear. These and similar expressions identify things or aspects in a relative way based on an express or arbitrary notion of perspective. That is, these terms are illustrative only, used for purposes of explanation, and do not necessarily indicate the only possible position, direction, and so on.

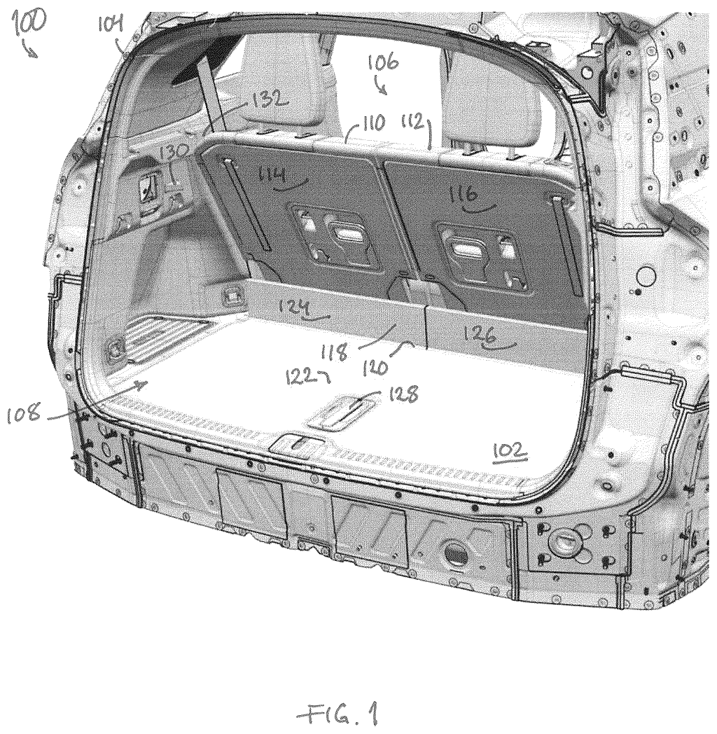

FIG. 1 shows an example of a vehicle 100 with a load floor 102. The vehicle 100 and/or the load floor 102 can be used with one or more other examples described elsewhere herein. The vehicle 100 is presented in a perspective view and is only partially shown for simplicity. The vehicle 100 includes a vehicle body 104 having a passenger compartment 106 (here partially visible through openings in the vehicle 100) and a trunk space 108.

The vehicle 100 can include one or more seats that can be transitioned between a deployed position (e.g., available for sitting by an occupant in the passenger compartment 106) and a stowed position (e.g., folded and placed in a sub-trunk compartment). Here, seats 110 and 112 are shown that are each currently in the deployed position. For example, the seats 110-112 can be positioned in a second row of seats, or in a third row of seats, or in any other subsequent row of seats. The seat 110 has a seatback 114 and the seat 112 has a seatback 116.

The load floor 102 can include multiple boards that facilitate various use positions. Here, the load floor 102 includes a board 118, a board 120, and a board 122. For example, the board 118 can be referred to as a front board, the board 120 can be referred to as a middle board, and the board 122 can be referred to as a rear board. The boards 118 and 120 can be hinged to each other. The boards 120 and 122 can be hinged to each other. The board 118 is currently in a rotated position, and the boards 120 and 122 are each currently in a flat position. In some implementations, the rotated position of the board 118 can ensure that the board 118 covers one or more mechanical features of the seats 110-112. For example, the load floor 102 can cover the mechanical features both in the deployed position (e.g., as shown) and in a stowed position (e.g., as described below). In some implementations, the board 118 can be split into separate boards corresponding to the number of the seats 110-112; here, the board 118 includes a left board 124 that is hinged to the board 120, and also a right board 126 that is hinged to the board 120.

The load floor 102 can be removable from the vehicle 100. In some implementations, the load floor 102 includes a handle 128 that can be used when removing/installing the load floor 102, and also for transitioning the load floor 102 between different use positions. For example, the handle 128 can be positioned at the board 122.

In some implementations, the board 122 can be rotated (about the hinge with the board 120) from the flat position shown into one or more rotated positions. The vehicle 100 can provide one or more features for maintaining the board 122 in the rotated position(s). In some implementations, a retainer mechanism 130 can be positioned at a side wall of the trunk space 108. The retainer mechanism 130 can have at least a first position where the board 122 can be rotated past the retainer mechanism 130, and a second position where the board 122 cannot be rotated past the retainer mechanism 130. The vehicle 100 can include interior trim 132 in the trunk space 108 (e.g., the interior trim 132 can be positioned near the passenger compartment 106). The interior trim 132 can serve to cover a portion of the vehicle body 104 with cloth, fabric, carpet or any other material, and can also provide one or more shapes to be used in the retention of the board 122 in the rotated position(s). In some implementations, the interior trim 132 is part of a quarter trim panel in the vehicle 100.

The vehicle 100 can include at least one other retainer mechanism in addition to the retainer mechanism 130. In some implementations, the other retainer mechanism can be positioned at an opposite side wall from the retainer mechanism 130. For example, the other retainer mechanism in addition to the retainer mechanism 130. In some implementations, the other retainer mechanism can include structure substantially corresponding to the retainer mechanism 130.

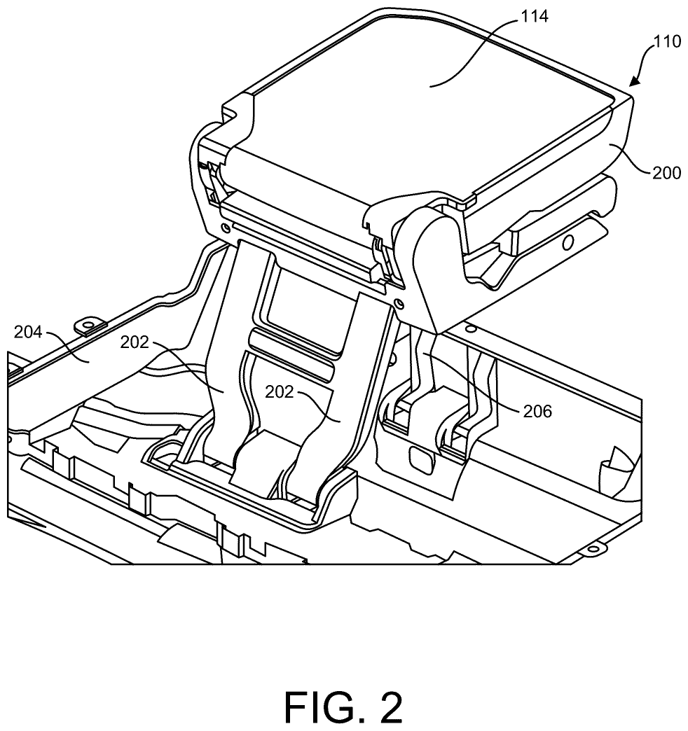

FIG. 2 shows an example of the seat 110 of the vehicle 100 of FIG. 1 in a folded position. The seat 110 can be used with one or more other examples described elsewhere herein. In the folded position, the seatback 114 has been folded to be substantially parallel with and at least partially overlapping a cushion 200 of the seat 110. The seat 110 can be supported by one or more main links 202 that are mounted with a sub-trunk compartment 204. A break link 206 can extend between the vehicle body and a frame supporting the cushion 200, and can control kinematics of the seat 110 in transition between the folded position and a stowed position.

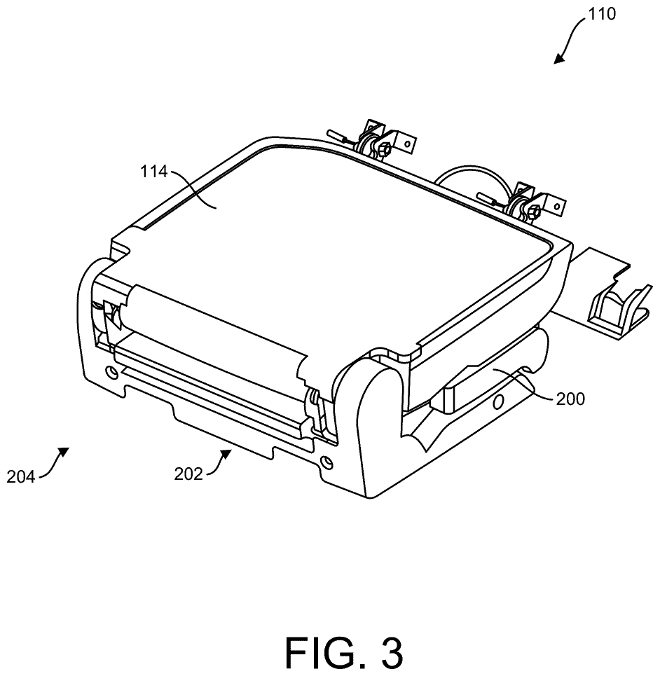

FIG. 3 shows an example of the seat 110 of the vehicle of FIG. 1 in a stowed position. The seat 110, with the seatback 114 folded against the cushion 200, is now positioned entirely inside the sub-trunk compartment 204. For example, the seatback 114 and the cushion 200 are positioned substantially above (e.g., on top of) the main link(s) 202 in the stowed position.

Each of the seats 110-112 (FIG. 1) can be individually transitioned to its respective positions. For example, both of the seats 110-112 can be in the deployed position (e.g., as shown in FIG. 1); or one of the seats 110-112 can be in the stowed position (e.g., as shown in FIG. 3) while the other seat is in a folded position (e.g., as shown in FIG. 2) or in a deployed position; or both of the seats 110-112 can be in the stowed position.

FIG. 4 shows an example of the vehicle 100 of FIG. 1 with the seats 110-112 in the deployed position. The vehicle 100 and the seats 110-112 are here shown with a different amount of detail than in FIG. 1 for illustrative purposes.

The seats 110-112 include mechanisms in an area 400 that are involved in the transition between deployed and stowed states. For example, the mechanisms can include pivot points and/or brackets for the main link(s) 202 and/or the break link 206 in FIG. 3. These mechanical aspects of the seats 110-112 are not inside the sub-trunk compartment 204. The load floor 102 can cover the area 400 in addition to covering the sub-trunk compartment 204. When the seats 110-112 are stowed, the left board 124 and the right board 126 of the board 118 can be rotated down to cover the area 400. For example, a person can rotate the right board 126 by hand or by pushing with cargo or another object. here, however, the left board 124 and the right board 126 remain in a rotated position. For example, the left board 124 can then cover certain mechanical features of the seat 110 which is in the deployed position, and the right board 126 can then cover certain mechanical features of the seat 111 which is also in the deployed position.

The load floor 102 is supported by one or more structures in the trunk space 108. In some implementations, the load floor 102 is supported by flanges 402 and 404 positioned adjacent the sub-trunk compartment 204. For example, each of the flanges 402-404 can be part of the structure of a side cargo compartment in the trunk space 108.

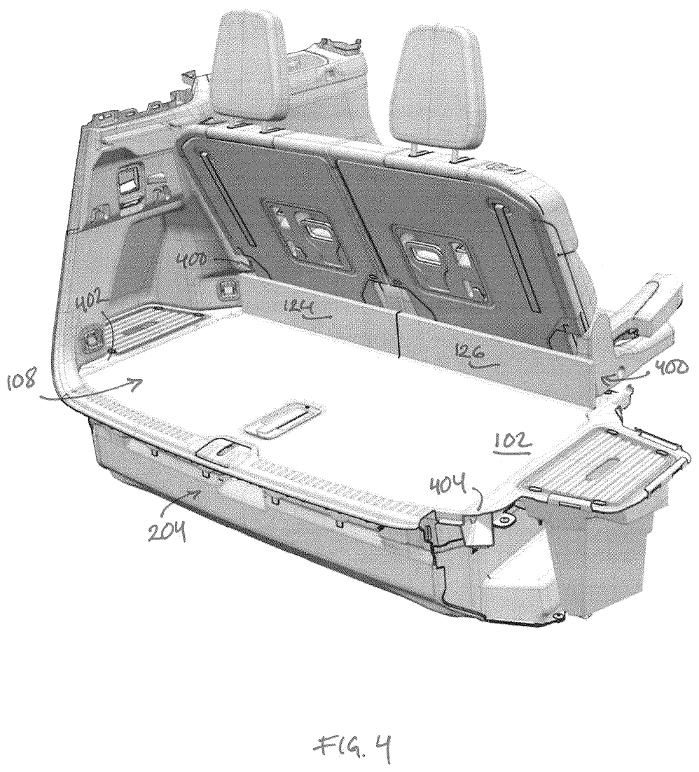

FIG. 5A shows an example of the vehicle 100 of FIG. 1 with the load floor 102 in a flat position. In this and the next illustration, the vehicle 100 is shown with an optional trailer hitch attached. Each of the seats 110-112 is here entirely accommodated within the sub-trunk compartment 204 and is therefore not visible in the present illustration. Each of the seats 110-112 includes mechanisms in the area 400 which are here covered by the board 118. Here, the left board 124 and the right board 126 have both been rotated down to cover the area 400. The load floor 102 here provides a generous cargo area extending through both the trunk space 108 and the passenger compartment 106.

FIG. 5B shows an example of the vehicle 100 of FIG. 1 with the board 122 of the load floor 102 in a rotated position. Thus, the sub-trunk compartment 204 is accessible.

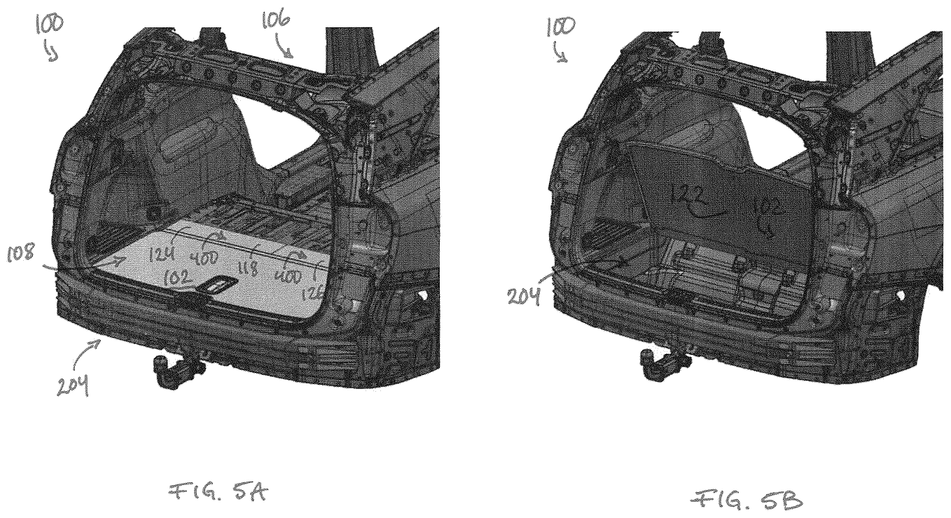

FIG. 6 shows an example of the load floor 102 of FIG. 1. As mentioned, the load floor 102 includes the boards 118-122 that can be a front, middle and rear board, respectively. The load floor 102 is here shown in a use case that involves each of the boards 118-122 in a flat (not rotated) position. For example, this use case can correspond to the arrangement of the load floor 102 used in FIG. 5A.

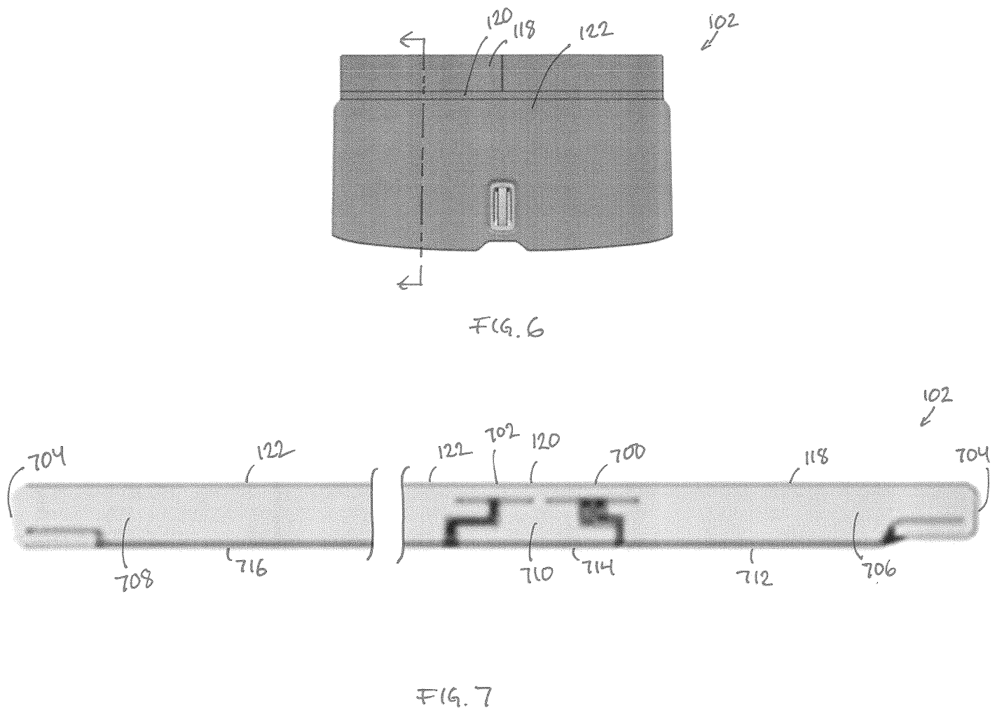

FIG. 7 shows an example cross section of the load floor 102 of FIG. 6. The boards 118-122 are shown, of which the board 118 and 122 are here shown truncated for simplicity. The boards 118 and 120 are hinged to each other by a hinge 700. The hinge 700 can be coupled at (e.g., mounted to) a distal edge of the board 120 and at (e.g., mounted to) a proximate edge of the board 118. The boards 120 and 122 are hinged to each other by a hinge 702. The hinge 702 can be coupled at (e.g., mounted to) a distal edge of the board 122 and at (e.g., mounted to) a proximate edge of the board 120. In some implementations, either or both of the hinges 700-702 can be a living hinge. A cover 704 can be applied over substantially an entire area of the load floor 102 where cargo is to be placed. In some implementations, the cover 704 can include carpet or another durable material. The cover 704 can be wrapped partially around a body 706 of the board 118 and a body 708 of the board 122, whereas a body 710 of the board 120 is partially covered by the cover 704. The bodies 706-710 can be made of any suitable material, including, but not limited to, plastic or metal. Each of the boards 118-122 can include one or more supporting surfaces on which the respective board can rest when the board is in a flat position. For example, the supporting surface can rest against either of the flanges 402-404 in FIG. 4. Here, the board 118 has a supporting surface 712, the board 120 has a supporting surface 714, and the board 122 has a supporting surface 716. The supporting surface can extend only in the area where the flange 402 or 404 abuts the board, or can extend substantially across the entire bottom face of the board. One or more of the supporting surfaces 712-716 can be an integral part of the respective bodies 706-710, or can be a separate material that is applied to the respective one or more of the bodies 706-710.

FIG. 8 shows an example of the load floor 102 of FIG. 1 in a position where the front board is in a rotated position. Here, the board 118 is rotated away from a flat position, whereas each of the boards 120 and 122 is currently in a flat position. In some implementations, the board 118 can have a nonzero angle with the board 120, including but not limited to a substantially upright position (e.g., about a 90 degree angle). The board 118 currently covers mechanical aspects of one or more seats 800 in the trunk space 108, the seat(s) 800 currently being in a deployed position. The boards 120-122 currently cover (i.e., provide a cargo loading surface above) the sub-trunk compartment 204. For example, the respective supporting surfaces of the boards 120-122 are currently abutted by the flanges 402/404 of the trunk space 108, whereas the flanges 402/404 do not abut the supporting surface of the board 118. The presently illustrated use case can correspond to the example shown in FIG. 4. As such, the boards 120-122 can here be used for stowing cargo, and the seat(s) 800 can seat the occupant(s).

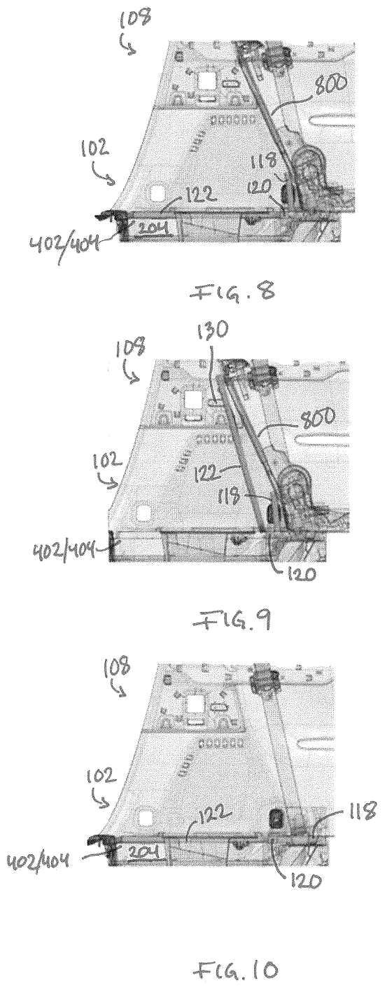

FIG. 9 shows an example of the load floor 102 of FIG. 1 in a position where the front and rear boards are in rotated positions. Here, the board 118 is rotated substantially as shown in FIG. 8, the board 122 is rotated away from a flat position to a rotated position, and the board 120 is currently in a flat position. In some implementations, the board 122 can have a angle with the board 120 that allows sufficient access to the sub-trunk compartment 204. The board can lean sufficiently away from a vertical line that gravity could cause the board 122 to rotate back to a flat position if the board 122 were not restrained (including but not limited to at about a 70-80 degree angle from horizontal). Here, the retainer mechanism 130 at least in part constrains the board 122 in its rotated position. The supporting surface of the board 120 is currently abutted by the flanges 402/404 of the trunk space 108. That is, an opening into the sub-trunk compartment 204 is currently provided by the rotation of the board 122, while the seat(s) 800 can be used to seat the occupant(s).

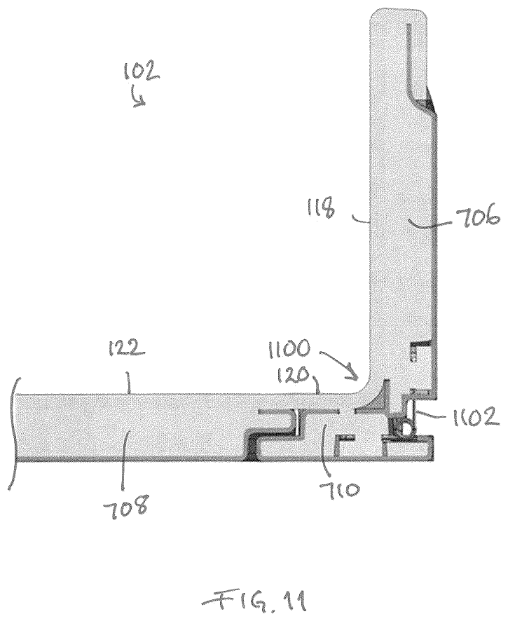

FIG. 10 shows an example of the load floor 102 of FIG. 1 in a position where all of the boards are in flat positions. As such, each of the boards 118-122 is currently in a flat position. This illustration shows the seat(s) 800 being in a stowed position inside the sub-trunk compartment 204. The board 118 currently covers mechanical aspects of the seat(s) 800 that are outside of the sub-trunk compartment 204. The load floor 102 currently covers (i.e., provides a cargo loading surface above) the sub-trunk compartment 204. For example, the respective supporting surfaces of each of the boards 118-122 are currently abutted by the flanges 402/404 of the trunk space 108. The presently illustrated use case can correspond to the example shown in FIG. 5A.

FIG. 11 shows an example of a hinge 1100 between the front and middle boards of the load floor 102 of FIG. 1. The hinge 1100 can be used with one or more other examples described elsewhere herein. The hinge 1100 here hinges the board 118 to the board 120. The board 122 is shown truncated for simplicity. The angle between the boards 118-120 is shown for illustrative purposes only. In some implementations, the hinge is bound to (e.g., attached to, or an integral part of) the body 706 of the board 118, and to the body 710 of the board 120. In some implementations, the hinge 1100 is a living hinge. The boards 120 and 122 can be hinged to each other, including, but not limited to, but a respective living hinge. For example, such a (living) hinge can be bound to the body 710 of the board 120, and to the body 708 of the board 122. A torsion spring 1102 can be provided between the board 118 to the board 120.

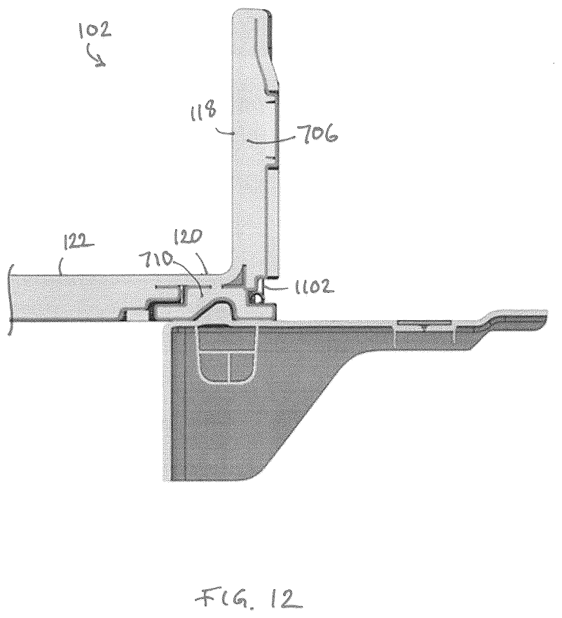

FIG. 12 shows another example of the front and middle boards of the load floor 102 of FIG. 1. The torsion spring 1102 is here bound to the board 118 and the board 120. The torsion spring 1102 can be coupled at (e.g., mounted to) a distal edge of the board 120 and at (e.g., mounted to) a proximate edge of the board 118. The board 122 is shown truncated for simplicity. In some implementations, the torsion spring 1102 is bound to (e.g., attached to, or an integral part of) the body 706 of the board 118, and to the body 710 of the board 120. In some implementations, a hinge (e.g., a living hinge) can also be provided between the boards 118-120.

The torsion spring 1102 provides a bias for the board 118 to assume a nonzero angle relative to the board 120. The angle between the boards 118-120 is shown for illustrative purposes only. In some implementations, the nonzero angle can be substantially the angle of the board 118 in any of FIG. 1, 4, or 8. For example, the nonzero angle can be about 90 degrees. The bias can facilitate that the load floor 102 can be installed, with the seat(s) deployed, without the user having to manually pull up the board 118 which may otherwise prevent the user from installing the load floor 102 correctly.

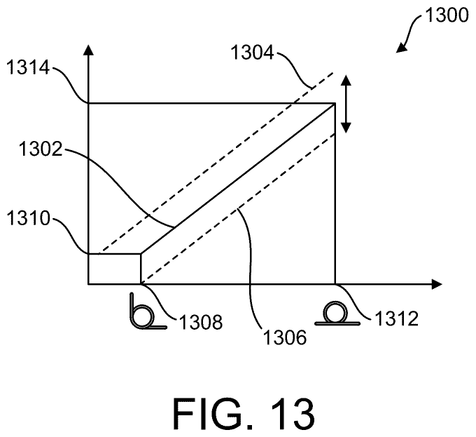

FIG. 13 shows a diagram 1300 with an example of bias on a board of a load floor. The diagram 1300 can be used with one or more other examples described elsewhere herein. The diagram 1300 shows torsion on a vertical axis as a function of relative angle on a horizontal axis. For example, with reference to FIG. 12, the relative angle in the diagram 1300 is the angle of the board 118 relative to the board 120 (e.g., the angle of the torsion spring 1200).

A graph 1302 shows the amount of torsion at various relative angles. Graphs 1304 and 1306 shown in dashed lines indicate deviations from the torsion of the graph 1302. For example, the graphs 1304-1306 can correspond to the natural variation in a torsion spring. The graph 1302 shows that a relative angle 1308 is associated with a torsion 1310. In some implementations, the relative angle 1308 is the natural state of the torsion spring where the torsion spring applies little or no tension. For example, the relative angle 1308 can correspond to the nonzero angle toward which the board 118 is biased by a torsion spring in any of FIG. 1, 4, or 8. If no force is applied to the board 118, the board 118 may assume the relative angle 1308 with the board 120. The graph 1302 shows that a relative angle 1312 is associated with a torsion 1314. In some implementations, the relative angle 1312 is a state where the board is held stationary against the bias of the torsion spring, and the torsion 1314 is therefore higher than the torsion 1310. For example, the relative angle 1312 can correspond to the flat position of the board 118 in any of FIGS. 5A or 10.

FIG. 14 shows an example of a magnet and a metal plate that can be used with a board of a load floor. This example shows a cross section of the board 118 and the flange 402/404 that can support the board 118. The board 118 and the flange 402/404 are shown truncated for simplicity. The magnet and the metal plate can hold the board 118 in contact with the flange 402/404, so that the flange 402/404 abuts the supporting surface 712 of the board 118, also in the presence of a bias on the board 118 from a torsion spring. For example, the torsion spring biases the board 118 toward assuming a nonzero angle relative to the flange 402/404.

At the body 706 of the board 118 a component 1400 can be positioned. For example, the component 1400 can be positioned inward of the supporting surface 712. At the flange 402/404 a component 1402 can be positioned. The components 1400-1402 magnetically attract each other. The component 1400 can be either a magnet or a metal plate, whereas the component 1402 is another of the magnet or the metal plate. As such, the board 118 can include a magnet and the flange 402/404 can include a metal plate, or vice versa. Absent the component 1400 or 1402 or both, the board 118 would assume the nonzero angle relative to the flange 402/404. However, attraction between the components 1400-1402 causes the flange 402/404 to abut the supporting surface 712 of the board 118. The board 118 can therefore assume a flat position.

The examples described above illustrate that a load floor (e.g., the load floor 102 in FIG. 1) can include: first, second and third boards (e.g., the boards 118-122), wherein the first board and the second board are hinged to each other, and wherein the second and third boards are hinged to each other; a torsion spring (e.g., the torsion spring 1102 in FIG. 12) providing a bias (e.g., as shown in the diagram 1300 in FIG. 13) for the first board to assume a nonzero angle relative to the second board (e.g., as shown in any of FIG. 1, 4, or 8); and either a magnet or a metal plate (e.g., the component 1400 in FIG. 14) included in the first board, the magnet or the metal plate configured for attraction to another of the magnet or the metal plate (e.g., the component 1402 in FIG. 14) to overcome the bias and cause the first board to assume an angle of about zero degrees relative to the second board.

The examples described above also illustrate that a vehicle (e.g., the vehicle 100 in FIG. 1) can include: a vehicle body (e.g., the vehicle body 104 in FIG. 1) having a passenger compartment (e.g., the passenger compartment 106 in FIG. 1) and a trunk space (e.g., the trunk space 108 in FIG. 1), wherein a sub-trunk compartment (e.g., the sub-trunk compartment 204 in FIG. 2) is formed in the trunk space; at least one seat (e.g., the seat 110 or 112 in FIG. 1) that is configured to transition between a deployed position and a stowed position, wherein in the deployed position the seat is positioned in front of the sub-trunk compartment and is available for sitting by an occupant in the passenger compartment, and wherein in the stowed position the seat is stowed inside the sub-trunk compartment; and a load floor (e.g., the load floor 102 in FIG. 1) to cover the sub-trunk compartment when the seat is in the deployed position and in the stowed position, the load floor comprising: first, second and third boards (e.g., the boards 118-122), wherein the first board and the second board are hinged to each other, wherein the second and third boards are hinged to each other, and wherein the load floor provides a bias for the first board to assume a nonzero angle relative to the second board; and either a magnet or a metal plate (e.g., the component 1400 in FIG. 14) included in the first board to overcome the bias and cause the first board to assume a zero angle relative to the second board.

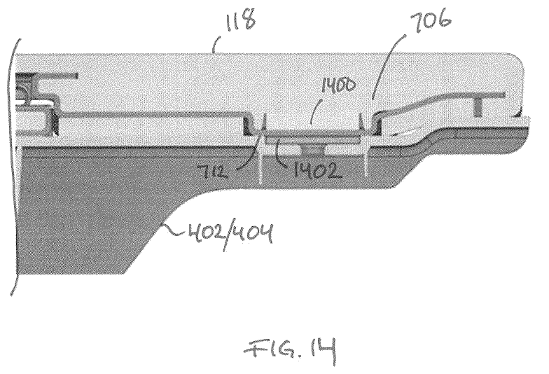

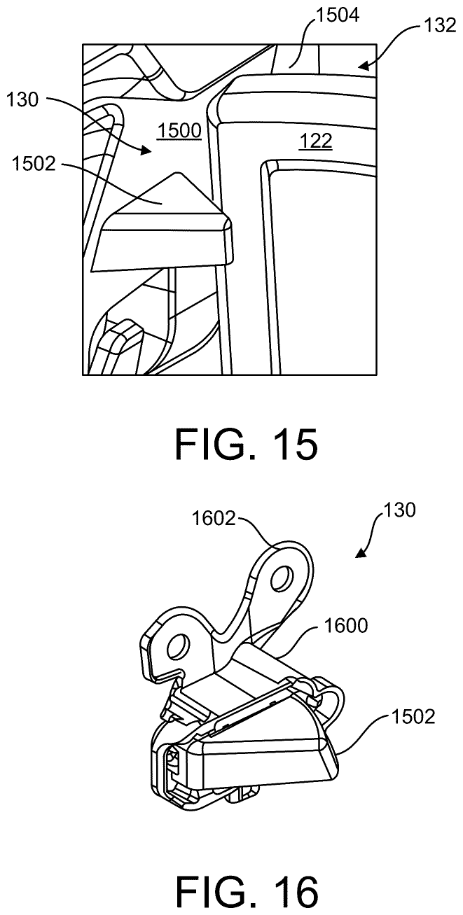

FIG. 15 shows an example of the retainer mechanism 130 of the vehicle 100 of FIG. 1 at a side wall 1500 of the trunk space 108. The retainer mechanism 130 can be used with one or more other examples described elsewhere herein. The retainer mechanism 130 includes a wedge-shaped member 1502 that is biased into an extended position (e.g., as shown). In this arrangement, the board 122 (of which only a portion is shown for simplicity) is confined between the wedge-shaped member 1502 in its extended position and a shape 1504 formed by the interior trim 132. The shape 1504 can include a ridge, a convex form, a bulge, an edge, or any other projecting structure.

The retainer mechanism 130 can allow the board 122 to be rotated into the confined position (e.g., the shown position) without the user having to manually actuate the wedge-shaped member 1502. Particularly, the retainer mechanism 130 can be configured so that as the board 122 is rotated toward the confined position, the wedge-shaped member 1502 is temporarily moved (e.g., rotated) by the board 122 against the bias of the retainer mechanism 130. This indirect actuation (i.e., not an actuation by hand) causes the wedge-shaped member 1502 to temporarily be moved toward a retracted position, thereby allowing the board 122 to rotate past the wedge-shaped member 1502 and into the confined position. When the board 122 assumes the confined position the wedge-shaped member 1502 returns to the extended position (e.g., the shown position), thereby confining board 122 between the shape 1504 and the wedge-shaped member 1502.

FIG. 16 shows an example of the retainer mechanism 130 of FIG. 15. The retainer mechanism 130 includes the wedge-shaped member 1502 mounted to a housing 1600. The housing 1600 can be configured for being mounted so as to be fully or partly hidden behind trim inside the vehicle. For example, the retainer mechanism 130 can be mounted inside a side wall of a trunk space so that the wedge-shaped member 1502 (in its extended position) protrudes from an opening in the trim. One or more attachments 1602 can be used for positioning the retainer mechanism 130 at the side wall.

FIG. 17 shows an exploded view of the retainer mechanism 130 of FIG. 16. The retainer mechanism 130 includes the housing 1600; an axle 1700 to be mounted to the housing 1600 in a substantially vertical orientation; the wedge-shaped member 1502 which defines a base contour 1702 and a pointed end 1704, wherein the axle 1700 is to extend through an opening at the pointed end 1704 to allow the wedge-shaped member 1502 to be rotated in a horizontal direction; a torsion spring 1706 to be mounted between the wedge-shaped member 1502 and the housing 1600 so as to bias the wedge-shaped member 1502 into an extended position; and a bumper 1708 to be mounted between the wedge-shaped member 1502 and the housing 1600 to absorb energy when the wedge-shaped member 1502 reaches its retracted position.

When the wedge-shaped member 1502 is in the extended position (e.g., as shown in FIG. 15), a portion of the base contour 1702 is positioned in the path for the board 122 to reach the rotated position. This facilitates the board 122 to temporarily move (e.g., rotate) the wedge-shaped member 1502 against the bias of the retainer mechanism 130 by indirect actuation, as mentioned above and thereby move past the retainer mechanism 130 and reach the rotated position.

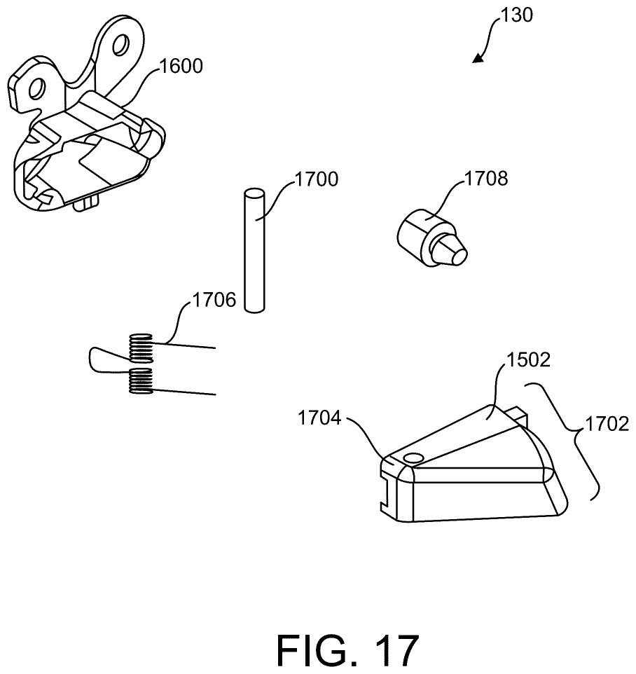

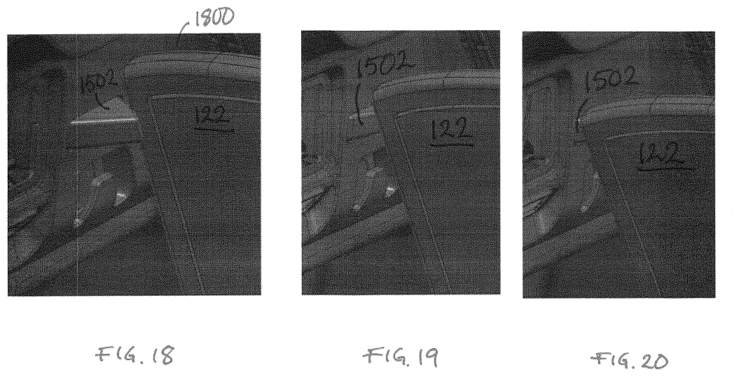

FIG. 18 shows an example of the board 122 of the load floor 102 of FIG. 1 being confined between the wedge-shaped member 1502 and the interior trim. A shape 1800 represents that the interior trim forms a protruding shape that can be used, together with the wedge-shaped member 1502 which is in its extended position, in confining the board 122 to a rotated position. In the rotated position, the board 122 can have a position similar to the one shown in FIG. 9. For example, the board 122 can lean from a vertical in a direction toward rotating back in a direction of the sub-trunk compartment. To release the board 122, the user can manually perform actuation of the wedge-shaped member 1502 away from the extended position. Upon the wedge-shaped member 1502 moving toward its retracted position, the board 122 can begin to rotate out of its confinement by the force of gravity acting on the board 122. That is, because the board 122 leans from vertical, it can begin moving upon no longer being confined by the wedge-shaped member 1502. The board 122 can then rotate to either of at least two positions: to a first position where the board 122 abuts the wedge-shaped member (e.g., as shown in FIG. 19), or to a second position past the wedge-shaped member 1502 (e.g., as shown in FIG. 20).

FIG. 19 shows an example where the board 122 of the load floor 102 of FIG. 1 abuts the wedge-shaped member 1502 of the retainer mechanism. The board 122 here temporarily prevents the wedge-shaped member 1502 from returning to the extended position. For example, the board 122 that began rotating due to gravity as a result of no longer being confined to the rotated position, has (at least temporarily) come to rest against the wedge-shaped member 1502. Due to the geometry of the wedge-shaped member 1502 and the force of gravity, the board 122 does not rotate back into the rotated position from this first position. Rather, the board 122 can remain in the first position while the user manually actuates another retention mechanism (e.g., that may be positioned at an opposite side wall of the trunk space).

FIG. 20 shows an example of the board 122 of the load floor of FIG. 1 in a position past the wedge-shaped member 1502 of the retainer mechanism. In this second position, there may be little or no resistance against continued rotation of the board 122 in the direction toward the sub-trunk compartment. However, if the board 122 is also confined by another retention mechanism (e.g., at the opposite side wall), the board 122 may remain in the second position substantially as shown. The user can then manually actuate the other retention mechanism to complete the return of the board 122 from its rotated position, so that the board 122 again assumes a flat position (e.g., as shown in any of FIGS. 1, 4, 5A, 8 or 10).

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

The invention claimed is:

1. A load floor to cover a sub-trunk compartment in a vehicle, the load floor comprising:
first, second and third boards, wherein the first board and the second board are hinged to each other, and wherein the second and third boards are hinged to each other;
a torsion spring providing a bias for the first board to assume a nonzero angle relative to the second board; and
either a magnet or a metal plate included in the first board, the magnet or the metal plate configured for attraction to another of the magnet or the metal plate to overcome the bias and cause the first board to assume an angle of about zero degrees relative to the second board.

2. The load floor of claim 1, wherein the first board is a front board, the second board is a middle board, and the third board is a rear board.

3. The load floor of claim 1, wherein the load floor is configured to be supported by flanges positioned adjacent the sub-trunk compartment, and wherein each of the first, second and third boards includes a respective supporting surface.

4. The load floor of claim 3, wherein in a first use position of the load floor the flanges abut the supporting surfaces of each of the first, second and third boards.

5. The load floor of claim 3, wherein in a second use position of the load floor the flanges abut the supporting surfaces of each of the second and third boards and the flanges do not abut the supporting surface of the first board.

6. The load floor of claim 3, wherein in a third use position of the load floor the flanges abut the supporting surface of the second board and the flanges do not abut the supporting surfaces of each of the first and third boards, wherein the first and third boards are in rotated positions and the second board is in a flat position.

7. The load floor of claim 3, wherein the magnet or the metal plate is configured so that attraction between i) the magnet or the metal plate and ii) another of the magnet or the metal plate positioned at the flanges causes the flanges to abut also the supporting surface of the first board.

8. The load floor of claim 1, wherein the first board and the second board are hinged to each other by a living hinge.

9. The load floor of claim 1, wherein the second and third boards are hinged to each other by a living hinge.

10. The load floor of claim 1, further comprising a handle.

11. The load floor of claim 10, wherein the handle is positioned at the third board, and wherein the third board is positioned at a rear of the load floor.

12. The load floor of claim 1, wherein the nonzero angle is substantially 90 degrees.

13. The load floor of claim 1, wherein the first board comprises i) a left first board that is hinged to the second board, and ii) a right first board that is hinged to the second board.

14. A load floor to cover a sub-trunk compartment in a vehicle, the load floor comprising:
a rear board, a middle board, and a front board, wherein the load floor is configured to be supported by flanges positioned adjacent the sub-trunk compartment, wherein each of the rear, middle and front boards includes a respective supporting surface, wherein in a first use position the flanges abut the supporting surfaces of each of the rear, middle and front boards, and wherein in a second use position the flanges abut the supporting surfaces of each of the rear and middle boards and the flanges do not abut the supporting surface of the front board;
a first hinge that hinges the rear board and the middle board to each other, the first hinge mounted to a distal edge of the rear board and to a proximate edge of the middle board;
a second hinge that hinges the middle board and the front board to each other, the second hinge mounted to a distal edge of the middle board and to a proximate edge of the front board; and
a torsion spring that biases the front board toward a nonzero angle relative to the middle board, the torsion spring mounted to the distal edge of the middle board and to the proximate edge of the front board;
wherein the front board includes either a magnet or a metal plate adjacent the supporting surface of the front board, wherein the magnet or the metal plate is configured so that attraction between i) the magnet or the metal plate and ii) another of the magnet or the metal plate causes the flanges to abut also the supporting surface of the front board.

15. The load floor of claim 14, wherein the first hinge is a living hinge.

16. The load floor of claim 14, wherein the first second is a living hinge.

17. The load floor of claim 14, wherein the nonzero angle is substantially 90 degrees.

18. The load floor of claim 14, wherein in a third use position the flanges abut the supporting surface of the middle board and the flanges do not abut the supporting surfaces of each of the front and rear boards, wherein the front and rear boards are in rotated positions and the second board is in a flat position.

19. A vehicle comprising:
a vehicle body having a passenger compartment and a trunk space, wherein a sub-trunk compartment is formed in the trunk space;
at least one seat that is configured to transition between a deployed position and a stowed position, wherein in the deployed position the seat is positioned in front of the sub-trunk compartment and is available for sitting by an occupant in the passenger compartment, and wherein in the stowed position the seat is stowed inside the sub-trunk compartment; and
a load floor to cover the sub-trunk compartment when the seat is in the deployed position and in the stowed position, the load floor comprising:
first, second and third boards, wherein the first board and the second board are hinged to each other, wherein the second and third boards are hinged to each other, and wherein the load floor provides a bias for the first board to assume a nonzero angle relative to the second board; and
either a magnet or a metal plate included in the first board to overcome the bias and cause the first board to assume a zero angle relative to the second board.

20. (canceled)

21. The vehicle of claim 19, wherein the load floor is configured to be supported by flanges positioned adjacent the sub-trunk compartment, and wherein each of the first, second and third boards includes a respective supporting surface.

22-58. (canceled)
